(19) United States
(12) Patent Application Publication
(10) Pub. No.: US 2015/0037521 A1
(43) Pub. Date: Feb. 5, 2015

(54) POCKETED CLEANING PAPER SYSTEM

(71) Applicant: Michael C. FINDLAY, Corona, NY (US)

(72) Inventor: Michael C. FINDLAY, Corona, NY (US)

(21) Appl. No.: 13/954,989

(22) Filed: Jul. 31, 2013

(51) Int. Cl. A47K 10/16; B31D 5/00

(52) U.S. Cl. CPC A47K 10/16; B31D 5/0086
USPC 428/34.2; 156/292

(57) ABSTRACT

A device and method for the creation of a multi-layer cleaning paper with pocket for insertion of a hand, finger, or other body part or object. The cleaning paper may be of the disposable form typical of paper towel, toilet paper, or tissue paper. The location of one or more seams joining the layers of cleaning paper along the edges of each sheet determine the number of pocket openings and orientation of the pocket openings on each sheet. The cleaning paper may be dispensed on a roll, with bisecting perforations between each sheet, or as individual stacked sheets.

### CROSS-REFERENCE TO RELATED APPLICATION

This application claims the benefit of provisional patent application no. 61/741,998 filed on Aug. 1, 2012.

### FEDERALLY SPONSORED RESEARCH

Not Applicable

### SEQUENCE LISTING OR PROGRAM

Not Applicable

### BACKGROUND

Cleaning paper is a disposable paper typically used for cleaning dirty surfaces. The disposable paper is commonly referred to as paper towel, toilet paper or tissue paper, and can be found as a series of sheets on a roll or as individual stacked sheets.

Disposable cleaning paper is widely used because it allows for a cleaning task to be undertaken without resulting in a soiled towel that must be disposed of or washed to be re-used. Many cleaning tasks involve interaction with harmful chemicals, such as paint thinner, or unappealing substances, such as human waste, where washing reusable towel is dangerous or unappealing.

The cleaning paper is used by grasping one or more sheets in hand and applying the cleaning paper to the surface or particular area of the body being cleaned. Because the paper is one flat sheet, a person's hand or fingers remain exposed and often time make unwanted contact with the surface or substance being cleaned. Although some people may wrap a series of cleaning paper sheets around their hand or fingers, this practice is inconvenient and wastes significantly more cleaning paper than necessary for the cleaning task. For the foregoing reasons, it would be desirable for a disposable cleaning towel that can be made in the same format as currently existing cleaning towels, yet prevent the user's hand or fingers from being exposed.

The solution is found in the present disclosure for a pocketed cleaning paper system, which comprises a sheet of cleaning paper having two or more layers and bonded on at least two edges. Each sheet of cleaning paper is formed into a pocket for the insertion of a user's hand or fingers during use, preventing accidental contact between the user and substance being cleaned.

### SUMMARY

The present disclosure is directed to a system that satisfies this need for a disposable cleaning paper that may be made in the same format as currently existing cleaning towels, yet prevent the user's hand or fingers from remaining exposed. The system comprises sheets of cleaning paper having two or more layers and bonded on at least two edges to form a pocket. The sheets may be stacked individually, as in the case of tissue papers, or affixed to each other in series as in the case of paper towel roll or toilet paper roll. Where the sheets are affixed to each other, a bisecting perforation between each sheet allows for detachment of each sheet from the other sheets.

Where a sheet is bonded along two opposing edges, a pocket with two opening is created at the remaining edges, allowing for insertion of a hand or fingers from either opening. Where a sheet is bonded along three edges, a pocket with one opening is created for insertion of a hand or fingers into the sheet. An additional seem may also be applied within the edges of the sheet to create a mitten or insertion of a hand. In either orientation, a user's hands or fingers remain between sheets of cleaning paper, protected from the substance being cleaned.

### DRAWINGS

FIG. 1 illustrates a front perspective view of a cleaning paper device embodying features of the present invention for a pocketed cleaning paper system.

FIG. 2 illustrates a front perspective view of an alternate embodiment of a cleaning paper device embodying features of the present invention for a pocketed cleaning paper system.

FIG. 3 illustrates a front perspective view of an alternate embodiment of a cleaning paper device embodying features of the present invention for a pocketed cleaning paper system.

FIG. 4 illustrates a front perspective view of an alternate embodiment of a cleaning paper device embodying features of the present invention for a pocketed cleaning paper system.

FIG. 5 illustrates a front and top perspective view of an alternate embodiment of a cleaning paper device embodying features of the present invention for a pocketed cleaning paper system.

FIG. 6 illustrates a front and top perspective view of an alternate embodiment of a cleaning paper device embodying features of the present invention for a pocketed cleaning paper system.

FIG. 7 illustrates a front and top perspective view of an alternate embodiment of a cleaning paper device embodying features of the present invention for a pocketed cleaning paper system.

FIG. 8 illustrates a front and top perspective view of an alternate embodiment of a cleaning paper device embodying features of the present invention for a pocketed cleaning paper system.

FIG. 9 illustrates a side perspective view of a cleaning paper embodying features of the present invention for a pocketed cleaning paper system.

FIG. 10 illustrates a side perspective view of a cleaning paper embodying features of the present invention for a pocketed cleaning paper system.

FIG. 11 illustrates a front elevation view of an alternate embodiment of a cleaning paper device embodying features of the present invention for a pocketed cleaning paper system.

### DESCRIPTION

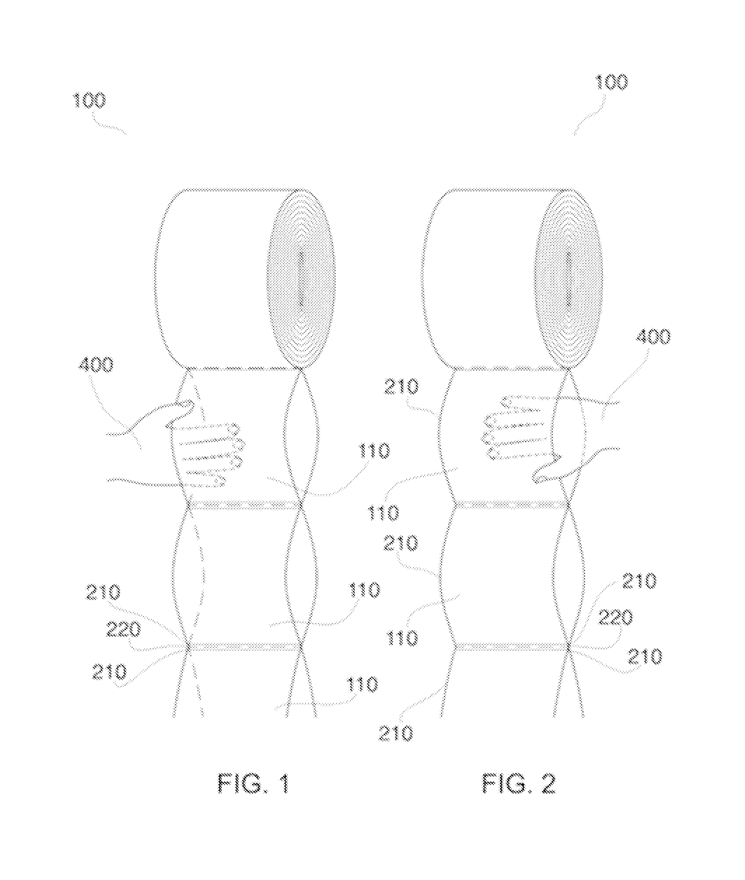

As shown in FIGS. 1-11, a pocketed cleaning paper system 100 comprises a sheet of cleaning paper 200 having two or more layers and having a bonded seam 210 along two or more edges to form a pocket as illustrated in FIGS. 1-2.

The cleaning paper 200 may be in the form of any shape plane, such as a square or rectangle. The cleaning paper 200 is like that typically used for paper towel, toilet paper, or tissue paper. The durability and absorbability of the cleaning paper 200 is like that typically used for paper towel, toilet paper, or tissue paper, and can be made from natural or synthetic materials, such as paper or cotton. The size of each sheet 110 may vary depending on the desired use of the pocketed cleaning paper system 100, but is preferably large enough so that a hand or at least one finger may be inserted into the pocket of each sheet 110.

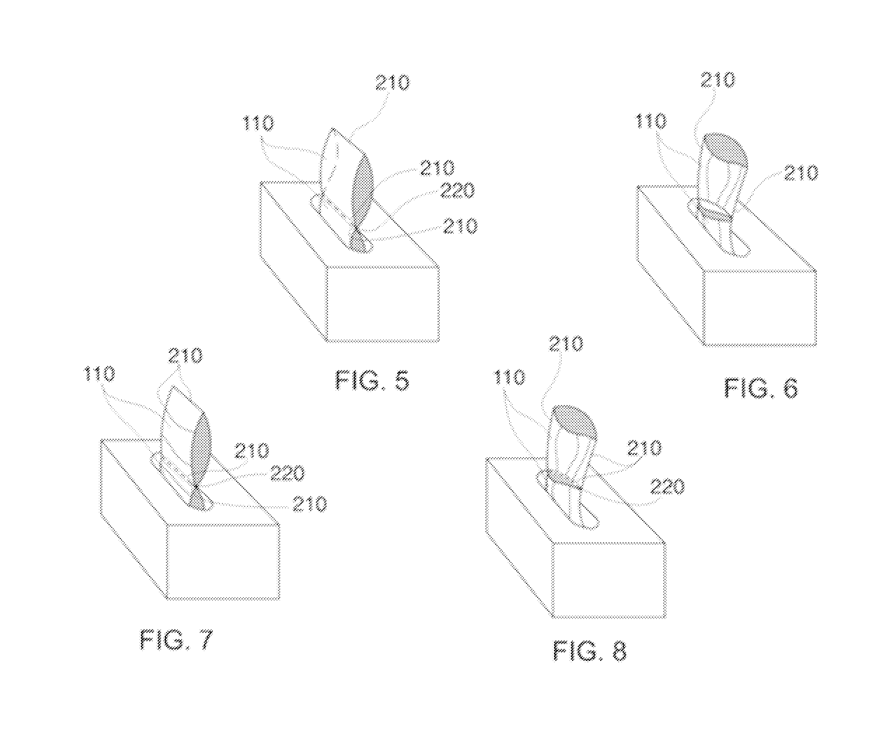

The pocketed cleaning paper system 100 can be configured as a roll of sheets 110 in series as illustrated in FIGS. 1-4, or as several sheets 110 stacked as illustrated in FIGS. 5-8. Where the sheets 110 are configured in a series, a perforation 220 that bisects the area between each sheet can be incorporated into the pocketed cleaning paper system 100.

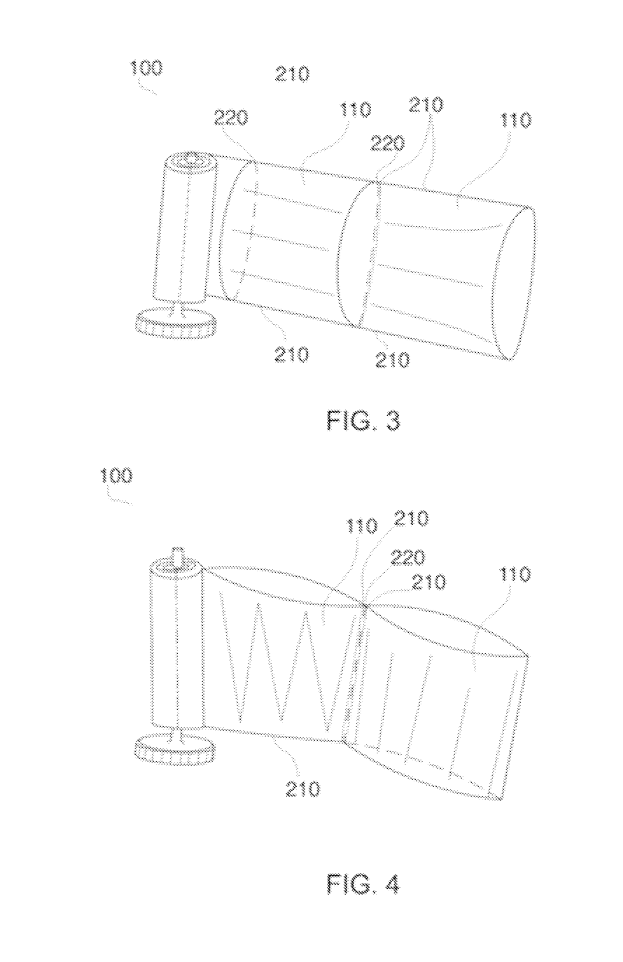

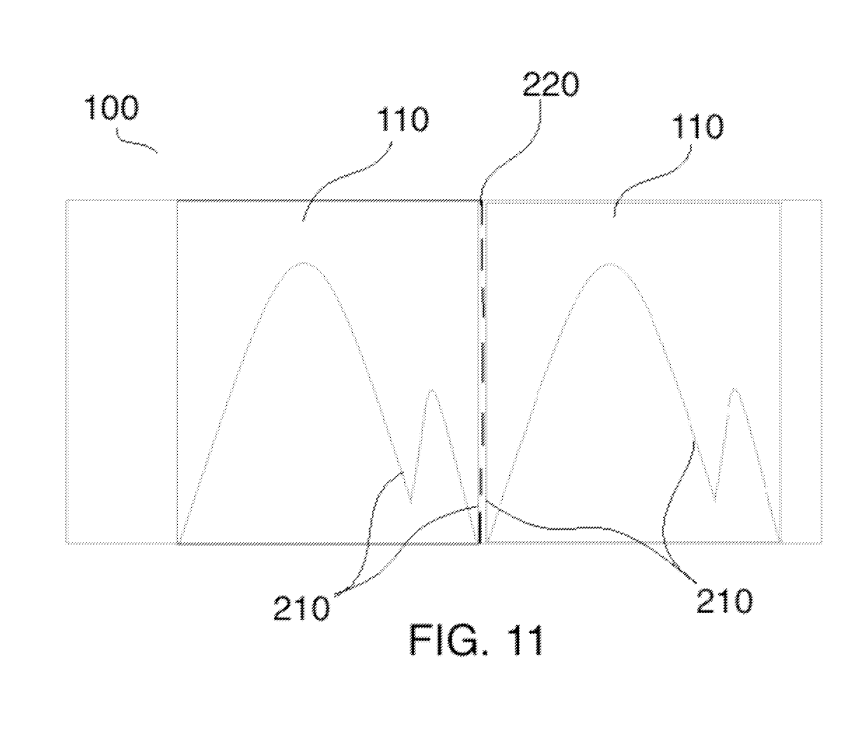

The edges of each sheet 110 may comprise seams 210 between the layers of cleaning paper 200 so that each sheet forms a pocket. The seams 210 may be created using methods typically used in the cleaning paper industry, such as bonding the layers together with adhesive. A seam 210 may be placed on two opposing edges of the sheet 110 as illustrated in FIGS. 1, 5 and 6. This orientation of seams 210 creates a pocket with two opposing openings. Alternatively, a seam 210 may be placed on three edges of a sheet 110 as illustrated in FIGS. 2, 7, and 8. This orientation of seams 210 creates a pocket with one opening. In yet another alternate embodiment, illustrated in FIG. 11, a seam 210 may be placed along a sheet 110 to form a mitten between the sheets 110 for insertion of a hand. Within each pocketed cleaning paper system 100, the orientation of seams may be alternated for each sheet 110 as illustrated in FIGS. 3-4.

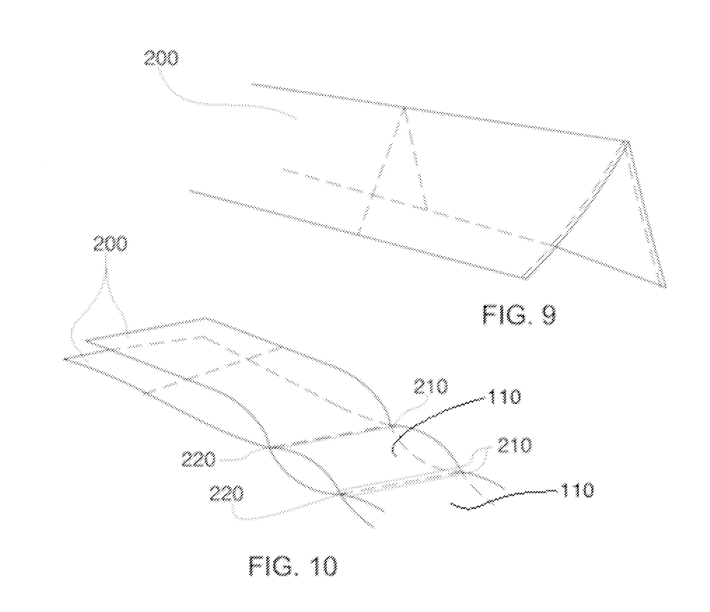

To make the pocketed cleaning paper system 100, several layers of cleaning paper 200 may be layered with seams 210 and perforations 220 applied to the cleaning paper 200 at the desired locations and lengths to create individual sheets 110 as illustrated in FIG. 10. Alternatively, a length of cleaning paper 200 may be folded along an edge and the seams 210 and perforations 220 applied at the desired locations and lengths to create individual sheets 110 as illustrated in FIG. 9.

To use the pocketed cleaning paper system 100, a user can remove a sheet 110 from the roll (FIGS. 3-4) or from the stack of sheets 110 (FIGS. 5-8). Next, the user simply inserts their hand or finger(s) into the sheet 110 as illustrated in FIGS. 1-2 and performs the specific cleaning task. Alternatively, the user may insert their hand or finger(s) into the sheet 110 while it is still on the roll or in the stack, and then pull to remove or detach the sheet 110.

All features disclosed in this specification, including any accompanying claim, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed:

1. A series of paper sheets, wherein each sheet comprises at least two or more layers, at least two sides of each sheet is bonded to enclose said at least two or more layers, so that each sheet forms a pocket, said series of paper sheets being formed by a paper sheet being affixed to an adjacent paper sheet or stacked over an adjacent paper sheet.

2. The series of paper sheets of claim 1, wherein each sheet further comprises a seam disposed along each sheet to form a mitten between each sheet.

3. A method for creating a pocketed cleaning paper comprising the steps of:
(a) Arranging at least one layer of cleaning paper;
(b) Affixing the layers of cleaning paper together with one or more seams along at least one edge of the cleaning paper to create a sheet having a pocket with at least one opening.

4. The method for creating a pocketed cleaning paper as defined in claim 3, wherein the seam is placed along opposing edges of the cleaning paper to create a sheet having a pocket with two openings.

5. The method for creating a pocketed cleaning paper as defined in claim 3, wherein the seam is placed along the edges of the cleaning paper to create a sheet having a pocket with one opening.

6. The method for creating a pocketed cleaning paper as defined in claim 3, wherein the seam is placed along the sheet to create a mitten between the layers of cleaning paper.

7. The method for creating a pocketed cleaning paper as defined in claim 3, wherein a series of seams is applied to the cleaning paper to create a series of individual sheets having a pocket with at least one opening.

8. The method for creating a pocketed cleaning paper as defined in claim 7, wherein a perforation bisecting the cleaning paper is applied to the cleaning paper to create a series of detachable sheets.
